(19) United States
(12) Patent Application Publication
(10) Pub. No.: US 2008/0033932 A1
(43) Pub. Date: Feb. 7, 2008

(54) CONCEPT-AWARE RANKING OF ELECTRONIC DOCUMENTS WITHIN A COMPUTER NETWORK

(75) Inventors: Colin E. DeLong, Minneapolis, MN (US); Sandeep V. Mane, Minneapolis, MN (US); Jaideep Srivastava, Plymouth, MN (US)

Correspondence Address: SHUMAKER & SIEFFERT, P. A., 1625 RADIO DRIVE, SUITE 300, WOODBURY, MN, 55125, US

(73) Assignee: Regents of the University of Minnesota, St. Paul, MN (US)

(21) Appl. No.: 11/769,509

(22) Filed: Jun. 27, 2007

Related U.S. Application Data
(60) Provisional application No. 60/816,804, filed on Jun. 27, 2006.

(51) Int. Cl. G06F 17/30

(52) U.S. Cl. 707/5; 707/E17.071

(57) ABSTRACT

Techniques are described for ranking the relevance of electronic documents, such as web pages. An algorithm extracts keywords and recurring phrases from the anchor tag data in electronic documents to define a set of concepts. The algorithm then uses link, concept pairs to create nodes in a graph. In this graph, edges can represent both explicit and implicit conceptual links between nodes. By including conceptual data, the algorithm may model and utilize inter-concept relationships when using graph ranking algorithms. This may improve result accuracy by not only retrieving links which are more authoritative given a users' context, but also by utilizing a larger pool of web pages that are limited by concept-space, rather than keyword-space.

This application claims the benefit of U.S. Provisional Application Ser. No. 60/816,804, filed Jun. 27, 2006, incorporated herein by reference.

### TECHNICAL FIELD

The invention relates to search engines, and, in particular, computer-implemented techniques for ranking web pages or other electronic resources for search.

### BACKGROUND

The increasing use of the World Wide Web (“the Web”) and the enormous amount of information available on Internet makes web search an important research problem. One of the important tasks of web search is to rank electronic documents, (e.g., web pages), to determine the importance of the web pages with respect to a user's query. Different ranking approaches have been proposed for assigning such authoritative weights to web pages.

For example, the PageRank algorithm assigns an authority weight to each web page using information about the link structure of the Web with respect to that particular web page. The approach is based on the assumption that a good (authoritative) page is usually pointed to by other good pages and hence must be ranked higher.

The Hypertext Included Topic Selection (HITS) algorithm uses a similar approach, but instead uses two vectors of authoritative vectors. This approach tends to work well only for queries on broad topics and in case of large number of relevant pages and hyperlinks.

### SUMMARY

In the prior art algorithms mentioned above, each web page is associated with keywords that are found in in-links to that web page. A web page is assumed to be equally knowledgeable of all such keywords related to the web page. Thus, a major limitation of these and similar ranking algorithms is that these algorithms assume that a web page with high authoritative weight is very knowledgeable of all terms related to it. This is known as topic drift. Philosophically speaking, a web page may not be equally informative about all related topics.

In general, the invention relates to techniques of improving the quality of results returned by a search of electronic documents. In particular, the techniques describe a way to automatically construct a concept-page graph. In a concept-page graph, a node represents a concept within a web page. In other words, each node corresponds to the unique pair of (web page, concept). To identify the concepts associated with a web page, anchor (link) text associated with all links from other web pages to that web page are extracted and concepts are automatically defined. This concept-page graph allows the link structure to capture dependencies between concepts. Such a concept-page graph can be used with a ranking algorithm. In addition, the techniques capture implicit links between different web pages having same concept.

The details of one or more embodiments of the invention are set forth in the accompanying drawings and the description below. Other features, objects, and advantages of the invention will be apparent from the description and drawings, and from the claims.

### DETAILED DESCRIPTION

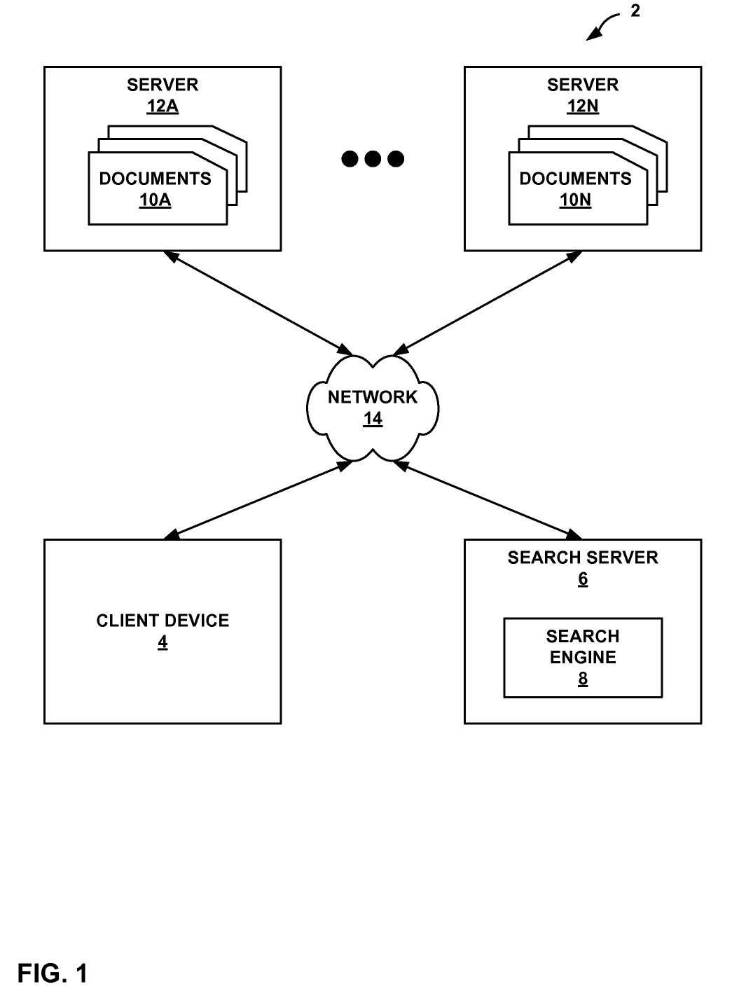

FIG. 1 is a block diagram illustrating an exemplary system 2 in which a client device 4 queries a search server 6 configured to run a concept-aware search engine 8 to search electronic documents 10 located on servers 12 on a network 14. In exemplary system 2, a user of client device 4 may need to locate information from one or more electronic documents 10 or other web resource. For example, documents 10 may be Hypertext Markup Language (HTML) web pages, documents conforming to the portable document format (PDFs), blogs, news groups or other types of resources that may be made available via the Internet or other large-scale computer network.

In one example, a user associated with client device 4 may need to located one of documents 10 that describes tuition rates. Because documents 10 may be too numerous to search manually, the user may send a query to search engine 8 operating on search server 6. In response to this query, search engine 8 sends a list containing references to any of documents 10 that satisfy the query. Search engine 8 orders the list according to the concept-aware ranking process described herein.

Before search engine 8 receives the query, search engine 8 performs a concept-aware ranking process. This concept-aware ranking process may allow search engine 8 to send a list to client device 4 that contains references to the most relevant or authoritative ones of document 10 that satisfy the query. By being aware of concepts, search engine 8 may identify which ones of electronic documents 10 are most authoritative on those concepts identified within the search terms provided by client device 4.

In general, search engine 8 performs a concept-aware ranking process by traversing (crawling) servers 12 and extracting concepts from documents 10. During this process, search engine 8 constructs a graph in which each node in the graph represents a (resource, concept) pair, where the resource are documents 10 in this example. That is, each of documents 10 may be represented by multiple nodes depending upon the number of concepts embodied within each of the documents. Moreover, each edge in the constructed graph represents a conceptual link from a first one of the documents to a second one of the electronic documents along a concept. In other words, each edge of the graph represents a (link, concept) pair identified within documents 10. Search engine 8 assigns a rank to each node in the graph based on the number of incoming edges to that node. After assigning a rank to each of the nodes, search engine 8 may response to the query with a list containing a subset of the nodes that is sorted in descending order according to the rank assigned to the node.

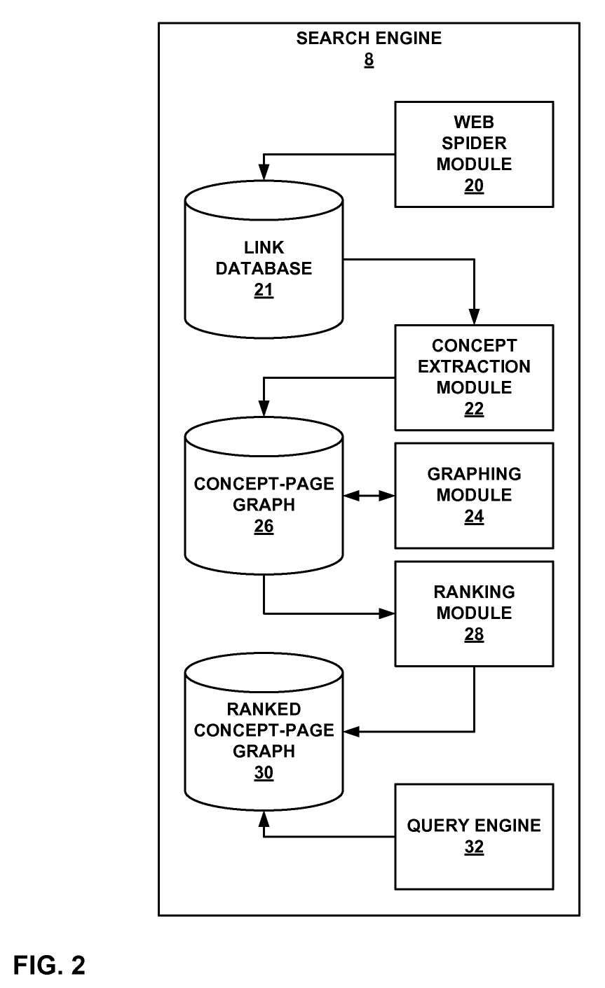

FIG. 2 is a block diagram illustrating an exemplary embodiment of a concept-aware search engine executing on a search server or a cluster of search servers. For purposes of explanation, reference may be made to the previous figure.

In the example embodiment illustrated in FIG. 2, search engine 8 comprises a web spider module 20. Web spider module 20 methodically accesses (“crawls”) documents 10 on servers 12. For each link web spider module 20 encounters in documents 10, web spider module 20 creates or updates an entry to a link database 21. In one embodiment, each entry lists a source page identifier of the link, a target page identifier of the link, and a link text. In general, such an entry may appear as:
{source_page_id, target_page_id, link_text}.
For example, suppose web spider module 20 encountered the following link in a Hypertext Markup Language (HTML) document located at www.example.com/example_{—}1.html:
<a href=“www.example.com/example_{—}2.html”>Concept-Aware Searching</a>.

In this case, web spider module 20 may output the following entry:

{www.example.com/example_1.html,
www.example.com/example_2.html, Concept-Aware Searching}

To create a concept-page graph, a concept extraction module 22 first extracts concepts from the entries in link database 21. In particular, for each unique {target_page_id, link_text} pair in link database 22, concept extraction module 22 compiles an array of the unique source_page_id's associated with that pair. During this process, concept extraction module 22 may ignore links with no anchor text. Not only is there no link text from which concept extraction module 22 can extract concepts, but other options such as using the universal resource locator (URL) as the link text may unfairly tilt concept extraction in favor of the target, since the URL is itself mutable by the target, and would make the process less democratic. For the same reason, concept extraction module 22 may also ignore links with only URLs as the anchor text.

For each {target_page_id, link_text} pair, concept extraction module 22 breaks the link text into an initial array of individual words. This is an initial array of concepts, which eventually contains multi-word concepts, but at this time may be viewed as a collection of terms. Concept extraction module 22 then initializes a concept array with word frequencies. A word frequency represents the number of unique sources for a particular {target_page_id, link_text} pair.

After initializing the concept array, concept extraction module 22 adds all possible left-to-right multi-word combinations of the link text to the concept array with the frequencies of the multi-word combinations initialized to the current unique source count.

For instance, concept extraction module 22 may employ the following pseudo-code to extract concepts:

```
for each {target_page_id, link_text, frequency, sources} {
    words = get_unique_words(link_text);
    for each {word in words} {
        temp_concepts[word] = frequency;
    }
    store_concepts(temp_concepts, target_page_id, sources);
    temp_concepts = get_multiword_concepts(words, frequency);
    store_concepts(temp_concepts, target_page_id, sources);
}
function get_multiword_concepts(words, frequency){
    mw_concepts = new Stack(words);
    all_text = words.implode(‘ ‘);
    while (mw_concepts.length > 0){
        cand = mw_concepts.pop( );
        for each (word in words){
            new_cand = cand + ‘ ‘ + word;
            if (
                word.length == 0 ||
                cand.length == 0 ||
                word == cand ||
                cand in word != false ||
                new_cand in all_text == false ||
                processed[new_cand] == true
                ) {
                continue;
                }
                p_mw_concepts[new_cand] = frequency;
                mw_concepts.push(new_cand);
                processed[new_cand] = true;
        }
    }
    return p_mw_concepts;
}
```

Once concept extraction module 22 adds the multi-word combinations to the concept array for a {target_page_id, link_text} pair, concept extraction module 22 stores the resulting array of concepts and frequencies for the {target_page_id, link_text} pair in a concept-page graph 26. If a concept already exists, concept extraction module 22 increments the frequency of the concept by the current unique source count. Additionally, concept extraction module 22 stores each unique {source_page_id, target_page_id, concept} in concept-page graph 26.

At this point, an un-pruned database of target_page_id's, their concepts, and the frequencies for each concept exists in concept-page graph 26. Since the concepts are “grown” identically for each unique link text string for each target_page_id, it is likely that multiple pages share some of the same concepts. First, however, a graphing module 24 prunes spurious concepts from the database.

First, graphing module 24 removes all concepts from concept-page graph 26 that occur only once globally (i.e.: for all possible target_page_id's). The intuition is motivated in part because single-occurring concept references tend to be of extremely low value, but also for performance reasons. Ideally, graphing module 24 seeks a collection of strong concepts linking different pages together, not a large number of weak concepts that exacerbate ranking time computation for almost no gain. A concept that is potentially strong should have at least two unique sources utilizing the same concept, which is an initial step towards limiting “concept farming” websites which might attribute concepts to other pages in order to boost their “in context” search result ranking.

Second, graphing module 24 removes all concepts from concept-page graph 26 which are string subsets of longer concepts having the same global frequency. This is because many of the concepts grown in the aforementioned method are not only meaningless, but offer no additional information. When thinking of concepts as connective pieces between pages, one wants to maximize the descriptive length of each concept before the concept starts to lose information. This is, in part, based on association rule generation, where one wants to create association rules having the maximum descriptive length as long as its support remains constant.

For example, consider the two concepts in the following table:

TABLE 1
Concept pruning example

| Concept | Frequency |
|---|---|
| Advising | 603 |
| advising web | 603 |

Here, “advising” and “advising web” have the same global frequency, and because graphing module 24 grew the concepts in the exact same way, the set of source page_id 's for both concepts is also the same. Thus, graphing module 24 removes the concept “advising” because the concept “advising” supplies no additional information. If the frequency of the concept “advising” were higher (and if the frequency of “advising” were to have a different frequency than “advising web”, the frequency of “advising” must be higher), then graphing module 24 would keep the concept “advising”. This is what is meant by maximizing the descriptive length of a particular concept. The intuition here is that graphing module 24 should minimize the storage capacity necessary for the concepts without sacrificing their descriptive strength.

Graphing module 24 may use other heuristics are used for pruning. For instance, graphing module 24 removes single-word concepts that are “stop words”, such as “an” or “his” or “awfully”. However, graphing module 24 may not remove concepts containing these words if the aforementioned descriptive length maximization logic holds. Also, graphing module 24 removes numbers and symbols, often found in link text in pages with a table of contents.

After pruning concept-page graph 26, graphing module 24 adds implicit links to the concept-page graph. Up to this point, graphing module 24 has generated all of nodes and edges in the concept-page graph from explicitly-defined links. That is, every edge represents a conceptual link from one URL to another URL along a particular concept, itself derived from text within the original anchor tag linking the two URLs. If, however, two URLs share a concept, but are not explicitly linked, graphing module 24 may add an implicit link to the concept-page graph 26.

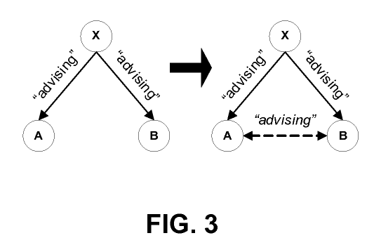

For example, suppose there are two page-concept pairs, {A, cᵢ} and {B, cᵢ}. If A and B are not linked to each other explicitly (i.e.: {A, B, cᵢ} or {B, A, cᵢ} do not exist in the concept-page graph), but share the same concept cᵢ, graphing module 24 adds the “missing” link to concept-page graph 26. In this way, graphing module 24 fills in gaps where shared concepts implicitly link pages. Thus, the subsequent ranking takes into account inter-page conceptual dependencies and, hence, allows a more accurate ranking of conceptual authorities. See FIG. 3 for a graphical example where cᵢ=“advising.”

In practice implicit linking seems to work better with smaller concept-page graphs, both in terms of improving search results and the actual computation of a concept-page graph's implicit links. For instance, site-specific spidering of the University of Minnesota's College of Liberal Arts (CLA) Student Services website (http://www.class.umn.edu) produces a regular web graph of 186 nodes and 2138 edges. Of the 2138 edges, 1120 are to seven of the top-level web pages for the website. In a site-specific search using only this web graph, since an overwhelming amount of PageRank is attributed to these seven nodes, these same nodes show up repeatedly in the search results, even though they may not be particularly authoritative about a given concept, only good hubs. The insertion of implicit links has the effect of bringing conceptual authorities (i.e.: web pages that contain content about a particular concept rather than links to other pages containing content) further up in rankings, since they have more incoming links than in a purely explicitly-defined web graph. In most contexts, this would seem unnecessary, biasing results towards content-heavy pages rather than just using the global rank (which ranks hubs highly). However, when done in the context of a concept-aware search engine, biasing results toward content-heavy pages is often a desirable trait (especially with smaller graphs). The reason is straightforward: rather than hubs that link to conceptual authorities, concept-aware search want conceptual authorities in search results. If the same seven nodes keep showing up in the search results for a site-specific search, then clearly the value of those results diminishes.

For a large web graph (and therefore, a much larger concept-page graph), the aforementioned problems with conceptual authorities tend to be mitigated. For instance, in a large graph, conceptual authorities tend to be more easily separated from low-value web pages because of deep links from external websites. However, in a small graph, there may be only a single link to a high-value conceptual authority, and if low-value nodes in the graph also have a single link to them, then using implicit links helps separate high-value conceptual authorities from low-value web pages.

Moreover, there may be serious performance issues when adding implicit links to a large concept-page graph. The size of the entire web graph for CLA's 85 spidered websites is 74,446 nodes and 725,749 edges. The pruned concept-page graph constructed from this web graph contains 314,049 nodes and 1,818,101 edges for some 55,600 distinct concepts. Even when several heuristics were applied to the implicit links calculation query, such as only generating edges where the nodes are from different domains and avoiding concepts which begin with prepositions, over 4,400,000 implicit links were generated, making PageRank over the eventual unique node graph (discussed in the next section) intractable for our experimentation. Addressing scalability issues with respect to implicit links generation/addition is part of our future work.

Once graphing module 24 has the pruned concept-page graph, a ranking module 28 begins a concept-aware ranking process. For instance, ranking module 28 may use the PageRank algorithm to calculate authorities of web pages for each concept associated with the web pages (i.e.: for all existing page-concept pairs). However, ranking module 28 performs several preparation steps before ranking module 28 calculates PageRank.

Under the “random surfer” model, web pages that do not have outgoing links are assigned outgoing links. However, in concept-aware ranking, ranking module 28 also assigns incoming links to web pages without incoming links. Since each node represents a concept-page pair, pages that do not have incoming links are not associated with any concepts and are not included in the ranking process. Ranking module 28 assigns such pages a “null” concept.

To assign the “null” concept, ranking module 28 randomly generates a source page and creates a new link to the page using the null concept for every page that does not have any incoming links. Once ranking module 28 has assigned random incoming links to all the untargeted pages, ranking module 28 may include these nodes in the graph PageRank utilizes.

In order for an unaltered version of the PageRank or HITS algorithms to utilize source data from the concept-page graph, ranking module 28 uses an adjacency matrix to create a temporary structure for the ranking process. Implemented in a database management system, such as MySQL from MySQL AB of Uppsala, Sweden, ranking module 28 transforms concept-page graph entries of the form:
{source_page_id, target_page_id, concept_id}
into the following form:
{source_node_id, target_node_id}
where both source_node_id and target_node_id represent unique concept-page pairs. After completing this step, every page has at least one concept, even if that concept is the “null” concept.

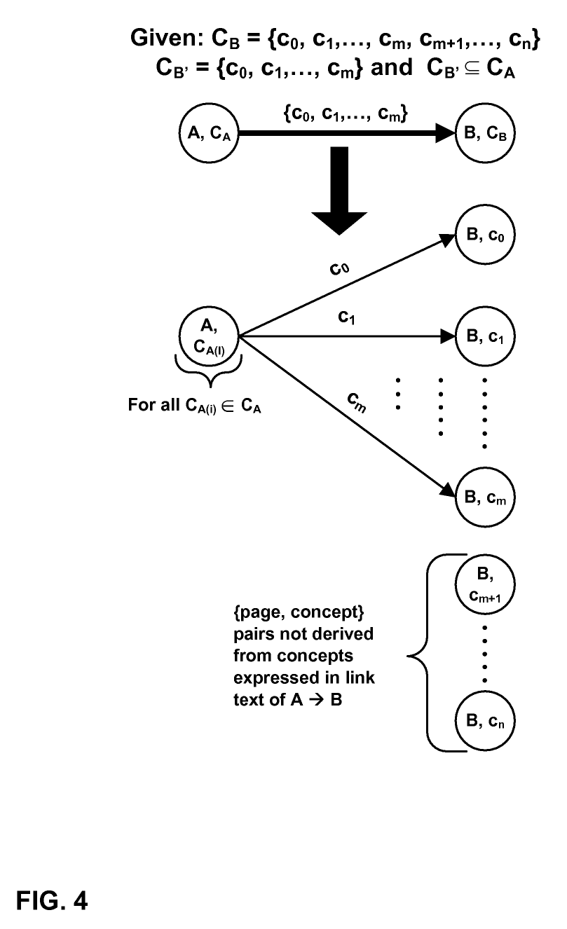

As such, ranking module 28 creates a temporary table of concept-page entries and generates a unique node_id for each entry. However, in order to obtain a sensible adjacency matrix, it is not enough to simply join this temporary table on itself where corresponding {source_page_id, target_page_id} entries exist in the concept-page graph. To do so could inadvertently introduce unnecessary entries into the adjacency matrix by assuming conceptual links between pages that are not intuitive. Rather, ranking module 28 observes the following rule constructing the adjacency matrix:
If A and B are web pages having sets of concepts C_{A} and C_{B}, and A links to B, and C_{B′} is the subset of concepts C_{B} for A linking to B, then {A, C_{A}} links to {B, C_{B′}}.
The reasoning here is that page A can only confer authority to B for the concepts which have been generated from the original anchor tag text which linked A to B in the first place. To assert otherwise is to say the scope of A and B's conceptual relationship is not limited to the concepts for which A asserted any authority to, that A confers some portion of PageRank to B for concepts originating from nodes other than A. This would contradict one of our original assertions, that for a particular web page, authority itself is not a global value, but one that varies from concept to concept. Thus, only the concepts existing in the link from A to B are used when constructing the adjacency matrix. FIG. 4 is a block diagram that illustrates that conceptual authority is derived from the referring hub.

The adjacency matrix resulting from the above logic is likely to be large when compared to the original concept-page graph. The aforementioned 1,818,101 edge concept-page graph for the University of Minnesota College of Liberal Arts (CLA), for instance, becomes 8,804,965 edges using this logic. Obviously, this causes PageRank to take longer than it would with a regular web graph (725,749 edges in the case of CLA). It would be much easier, given PageRank's time complexity, to simply run PageRank on subgraphs pertaining to each individual concept. In doing this, however, one would lose all of the inter-concept relationships (and thus, the authority conferred from a concept to another concept via the links shared by their web pages). Furthermore, for extremely rare concepts, the resulting graphs could have very few edges or fail to have any edges at all (unless implicit links were used, which for a single concept, would create a graph containing nothing but bi-directional links).

After ranking module 28 has built the adjacency matrix, ranking module 28 may run an unaltered version of PageRank to determine conceptual authorities. After running PageRank, ranking module 28 may insert the resulting ranked page-concepts into a ranked page-concept graph 30.

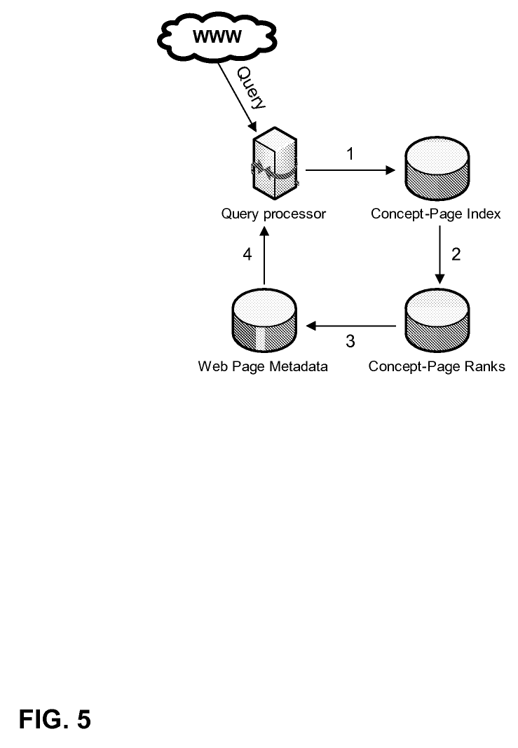

To respond to a query, a query processor 32 first breaks search terms (or keywords) entered by a user into an array of individual words. Query processor 32 then uses the keyword array, as well as the original search phrase, to query ranked concept-page graph 30. In this sense, ranked concept-page graph 30 may be thought of as an inverted index of concepts. Query processor 32 next groups the results by page_id. Query processor 32 then sums the concept ranks for each unique page_id (as pages often match on multiple concepts for a single multi-word query). Query processor 32 then retrieves metadata for each of the pages. For instance, query processor 32 may retrieve a page title from the header information of each page. Finally, query processor 32 returns to the pages to the user as search in descending order of summed concept rank. FIG. 5 is a conceptual diagram illustrating such a concept-aware query process.

Concept-aware models may have several advantages over “bag of words” models. For example, multi-word concepts are more discriminating representations of concepts compared to single-word concepts, as they capture aspects of language which a “bag of words” model essentially throws away. “Academic advising”, for instance, is a more discriminating form of “advising”, but not all advising is purely academic. For instance, there is also “career advising”. If someone were to search for “academic advising”, a search utilizing concepts may be less likely to pull highly-ranked information on “career advising”. This may help cut down on irrelevant search results for closely-related concepts.

In addition, multi-word concepts are often themselves unique concepts due to the incorporation of word order. For example, “student services” is composed of “student” and “services”, but “student services” is itself a unique concept that a concept-aware model is capable of modeling. In contrast, a “bag of words” model might only consider the co-occurrence of the two words and not the connective information inherent in the placement of “student” before “services”.

In another example, multi-word concepts may also allow for the creation of a richer conceptual hierarchy. Not only can a concept-aware model infer which single-word concepts are related to other single-word concepts, but a concept-aware model may also infer whether single-word concepts have interesting subgroups of multi-word concepts. “Advising” is a good example, as there are several kinds of advising in higher education.

Experimental Results

In order to better understand how concept-aware ranking performs both in terms of its implementation and search result relevance, a series of experiments were conducted. In general, these experiments fall into three areas: search result quality, graph construction scaling, and ranking time complexity.

All of the data used in these experiments are from the University if Minnesota's College of Liberal Arts (CLA) websites, 85 of which are spidered on a weekly basis, indexing and retrieving 74,446 unique web pages and 725,749 links (as of this papers' writing). After sink pages have been addressed, the regular web graph 770,254 edges and 74,446 nodes. For the concept-aware portion, there are two data structures: the concept-page graph and the adjacency matrix used during ranking. The concept-page graph contains 1,818,101 edges, 314,049 nodes, and 55,600 concepts. The adjacency matrix (which in the DBMS, is just a collection of {source, target} pairs) contains 8,804,965 edges and 314,049 nodes.

All experiments were conducted on the same application server and database server using the same DBMS and programming environments. The application server was a Pentium III 1 GHz with 4 GB RAM and (8) 18.2 GB 10K U160 SCSI hard drives in RAID5 configuration, while the database server was a Dual-Opteron 248 with 4 GB DDR400 RAM and (3) 73 GB 15K U320 SCSI hard drives in RAID5 configuration. They were connected via a private gigabit network. The development environment was Linux/Apache/PHP/MySQL (LAMP), running PHP 4.3.10 and MySQL 5.0.18-max.

For both concept-aware ranking and regular ranking (both using PageRank), ten iterations were used with a damping factor of 0.15. Additionally, both ranking implementations used the same table engines for their temporary data (MEMORY) and persistent data (MyISAM) using identical attribute and index sizes where schema congruencies existed.

The URL of our test search engine, which was selectable between concept-aware search and regular PageRank search, is located at http://teste.class.umn.edu/search_test.html. In these experiments, the only metric used to rank the results is each search types' respective PageRank values (either concept-aware or regular). Commonly-used heuristics such as title/phrase weighting were not used as the experiments were only designed to test the strength of the individual ranking methods.

a. Search Result Quality

To measure search result quality, a spider database (which also tracks queries by users) was queried to find the top 10 most popular queries, which are shown in the table below. The experimenters selected these search terms for the experiments because they are the most common queries made by visitors to CLA's websites. The experimenters used standard precision metric for search result performance measurement. The experimenters only considered the first twenty-five results in the computing the precision values for each query and search type. The results are shown in Table 2 below.

TABLE 2
Top queries to CLA websites
Top Search Terms

| | |
|---|---|
| 1. | deans list |
| 2. | majors |
| 3. | scholarships |
| 4. | graduation |
| 5. | orientation |
| 6. | advising |
| 7. | music |
| 8. | study abroad |
| 9. | tuition |
| 10. | psychology |

TABLE 3
Precision values for concept-aware/regular search

Precision
(out of 25 results)

| | concept- | |
|---|---|---|
| Search Terms | aware | Regular |
| Advising | 96% | 16% |
| dean's list | 8% | 4% |
| Graduation | 100% | 8% |
| Majors | 100% | 24% |
| Music | 80% | 12% |
| Orientation | 20% | 8% |
| psychology | 96% | 60% |
| scholarships | 96% | 12% |
| study abroad | 80% | 0% |
| tuition | 20% | 40% |

As can be seen from the results above, concept-aware search performs much better than regular search. As used herein, regular search is just sorting results on the global PageRank value for the web documents matching the search terms. In general, regular search returned hub pages (i.e.: web pages that are link-heavy) while concept-aware search returned content-heavy pages (though relevant hubs were mixed in as well).

For instance, regular search using the “majors” and “scholarships” terms returned links to the home pages of departments and major-centric academic advising offices, which have navigational links to major and scholarship information. Concept-aware search, on the other hand, was able to return the actual sub-pages referred to by the main page navigation, essentially going a step further than regular search. This pattern was consistent across nearly all the tested search terms.

There was confusion by both concept-aware and regular search for the search term “orientation”, which returned results for Simulink block orientation as well as Freshman/Transfer Student Orientation. Refining the query to “freshman orientation” improves the results for concept-aware search, but the same is not true for regular search, which instead weights results heavily towards URLs mentioning the word “freshman”, but are not necessarily about “freshman”.

The other two cases in which both search methods performed poorly or below average were the search terms “dean's list” and “tuition”, which is primarily because there were only a handful of pages across all of CLA's websites pertaining to either the Dean's List or tuition. The Dean's List, for example, resided in one location (http://www2.cla.umn.edu/news/deans_list.html), while most pages mentioning tuition linked to the Office of The Registrar (OTR) for more information. It is interesting to note, however, that concept-aware search only returned five results for this particular query, and every single one was a page about tuition, rather than pages linking to OTR for tuition information.

b. Graph Construction Scaling

Here the experiments present a comparison of graph size with respect to raw edge/node counts, as well as average out-degree and in/out-degree standard deviations.

TABLE 4
Graph size

| Structure | Edges | Nodes | Concepts |
|---|---|---|---|
| Regular web | 770,254 | 74,446 | NA |
| graph | | | |
| concept-page | 8,804,965 | 314,049 | 55,600 |
| adjacency matrix | | | |

TABLE 5
In-degree/Out-degree information

| | Avg. | | |
|---|---|---|---|
| Structure | Out-degree | StdDev Out-degree | StdDev In-degree |
| regular web graph | 10.3465 | 24.2418 | 50.2045 |
| concept-page | 28.0369 | 70.915 | 220.215 |
| adjacency matrix | | | |

Clearly, the concept-page adjacency matrix was much larger than the regular web graph in every measure. It had 11.43 times the number of edges and 4.2 times the number of nodes compared to the regular web graph. Given that the system used concept-page pairs as nodes, rather than just the page by itself, this was not a surprising revelation.

c. Ranking Time Complexity

The offline ranking times of each graph type—the regular web graph and the concept-page adjacency matrix—are shown in Table 6.

TABLE 6
Iteration times (in seconds)

| Structure | Avg. Time/Iteration | Total Time |
|---|---|---|
| regular | 79.92 s | 799.16 s |
| web graph | | |
| concept- | 484.35 s | 4843.52 s |
| page | | |
| adjacency | | |
| matrix | | |

Again, it was unsurprising to see that it takes longer per PageRank iteration for the concept-page adjacency matrix than does for the regular web graph. As the number of nodes grew and in-degree counts grew for each node (when moving from a regular web graph to a concept-page adjacency matrix), iterative computations took longer as well. However, this growth in computation time may present a major scalability issue. In order to be commercially viable on the World Wide Web, the scalability issue would have to be addressed more fully. In conducting these tests, the experimenters only included relatively minor optimizations. For example, the experimenters maintained a temp table for node out-degrees and used main memory tables for intermediate calculations wherever possible.

However, present-day search engines also face scaling issues. Since the concept-aware ranking system does not alter PageRank itself, advances in speeding up PageRank calculations would speed up a concept-aware ranking system that uses PageRank. In fact, recent advances in calculating PageRank have shown promise in workload reduction using novel graph partitioning and patch-marking techniques. Such methods may mitigate the scalability issue.

Various embodiments of the invention have been described. These and other embodiments are within the scope of the following claims. The techniques may be implanted on a programmable microprocessor configured to execute software instructions.

1. A computer-implemented method comprising:
extracting a set of concepts from a set of electronic documents from a computer network;
constructing a graph having nodes interconnected by edges, wherein each of the nodes in the graph represents an electronic document in the set of documents and a concept extracted from that electronic document, and further wherein each of the edges in the graph represents a link from a first one of the electronic documents to a second one of the electronic documents for a corresponding one of the concepts;
assigning a rank to each node in the graph based on a number of incoming edges connecting to the node; and
responding to a query with a list containing a subset of the nodes, wherein the list is sorted according to the rank assigned to the nodes.

2. The method of claim 1, wherein extracting a set of concepts comprises:
compiling an array of source page identifiers, wherein each of the source page identifiers in the array is associated with a pair comprising a target page identifier and a link text associated with the link from source page to the target page; and
for each of the pairs:
adding all individual words in the link text into a concept array;
initializing the concept array with word frequencies;
adding all left-to-right multi-word combinations of the link text to the concept array; and
initializing the concept array with the frequencies of the multi-word combinations.

3. The method of claim 1, wherein constructing a graph comprises:
removing concepts from the graph that occur only once globally; and
removing concepts from the graph which are string subsets of longer concepts having a common global frequency.

4. The method of claim 1, wherein constructing a graph comprises adding implicit links to the graph.

5. The method of claim 1, wherein assigning a rank comprises:
transforming graph entries the form {source_page_id, target_page_id, concept_id} into the form {source_node_id, target_node_id};
generating an adjacency matrix using the transformed graph entries; and
applying a PageRank algorithm to the adjacency matrix.

6. The method of claim 5, further comprising assigning a “null” concept to pages that do not have incoming links.

7. The method of claim 1, wherein responding to a query comprises:
breaking search terms of the query into individual words;
querying a ranked concept-page graph with the individual words to retrieve one or more result nodes;
assembling the result nodes into groups, wherein the result nodes in each of the groups refers to a common one of the electronic documents;
determining sums for each of the groups, wherein each of the sums equals the sum total of the rank assigned to each result node in one of the groups; and
returning a list containing the common electronic documents in order of sums for each of the groups.

8. A computing device comprising:
a concept extraction software module executing on the computer device to extract a set of concepts from a set of electronic documents;
a graphing software module executing on the computing device to construct a graph, wherein each node in the graph refers to an electronic document in the set of documents and a concept extracted from that electronic document, and wherein each edge in the graph represents a conceptual link from a first one of the electronic documents to a second one of the electronic documents along a concept;
a ranking software module executing on the computing device to assign a rank to each node in the graph based on a number of incoming edges connecting to the node; and
a query engine software module executing on the computing device to respond to a query with a list containing a subset of the nodes, wherein the list is sorted according to the rank assigned to the nodes.

9. The computing device of claim 8,
wherein the concept extraction module compiles an array of source page identifiers, wherein each of the source page identifiers in the array is associated with a pair comprising a target page identifier and a link text; and
wherein for each of the pairs, the concept extraction module:
adds all individual words in the link text into a concept array;
initializes the concept array with word frequencies;
adds all left-to-right multi-word combinations of the link text to the concept array;
initializes the concept array with the frequencies of the multi-word combinations.

10. The computing device of claim 8,
wherein the graphing module removes concepts from the graph that occur only once globally; and
wherein the graphing module removes concepts from the graph which are string subsets of longer concepts having a common global frequency.

11. The computing device of claim 8, wherein the graphing module adds implicit links to the graph.

12. The computing device of claim 8,
wherein the ranking module transforms graph entries the form {source_page_id, target_page_id, concept_id} into the form {source_node_id, target_node_id};
wherein the ranking module generates an adjacency matrix using the transformed graph entries; and
wherein the ranking module applies a PageRank algorithm to the adjacency matrix.

13. The computing device of claim 8, wherein the ranking module assigns a “null” concept to pages that do not have incoming links

14. The computing device of claim 8,
wherein the query engine module breaks search terms of the query into individual words;
wherein the query engine module queries a ranked concept-page graph with the individual words to retrieve one or more result nodes;
wherein the query engine module assembles the result nodes into groups, wherein the result nodes in each of the groups refers to a common one of the electronic documents;
wherein the query engine module determines sums for each of the groups, wherein each of the sums equals the sum total of the rank assigned to each result node in one of the groups; and
wherein the query engine module returns a list containing the common electronic documents in order of sums for each of the groups.

15. A computer-readable medium comprising instructions, the instruction causing a programmable processor to:
extract a set of concepts from a set of electronic documents;
constructing a graph, wherein each node in the graph refers to an electronic document in the set of documents and a concept extracted from that electronic document, and wherein each edge in the graph represents a conceptual link from a first one of the electronic documents to a second one of the electronic documents along a concept;
assign a rank to each node in the graph based on a number of incoming edges connecting to the node; and
respond to a query with a list containing a subset of the nodes, wherein the list is sorted according to the rank assigned to the nodes.
